(19) United States
(12) Patent Application Publication
(10) Pub. No.: US 2011/0300050 A1
(43) Pub. Date: Dec. 8, 2011

(54) Trichlorosilane Vaporization System

(75) Inventors: Abarajith Hari, Houston, TX (US); Zhihui Gu, Houston, TX (US); Satish Bhusarapu, Houston, TX (US); Timothy Truong, Pearland, TX (US); Puneet Gupta, Houston, TX (US)

(73) Assignee: MEMC ELECTRONIC MATERIALS, INC., St. Peters, MO (US)

(21) Appl. No.: 12/796,360

(22) Filed: Jun. 8, 2010

(51) Int. Cl. C01B 33/03; F28D 1/04; F28F 1/40

(52) U.S. Cl. 423/349; 165/163; 165/181; 392/397

(57) ABSTRACT

A heat exchanger for vaporizing a liquid and a method of using the same are disclosed herein. The heat exchanger includes a housing, a tube, a heater, and a plurality of non-reactive members. The tube is disposed in the interior of the housing and has an inlet and an outlet. The heater is configured to heat the tube. The plurality of non-reactive members are disposed in an interior cavity of the tube in an arrangement such that a plurality of voids are defined between the members and the tube. The arrangement also permits liquid to pass through the voids and travel from the inlet of the tube to the outlet of tube. The plurality of non-reactive members and the tube transfer heat to the liquid as the liquid passes through the plurality of voids in order to vaporize the liquid.

### BACKGROUND

Trichlorosilane in its gaseous state is often used in the manufacture of silicon-containing devices, such as semiconductor wafers or solar cells. Under normal atmospheric conditions, trichlorosilane is in a liquid state. It is converted to its gaseous state prior to use in the manufacture of silicon-containing devices. Moreover, when converting liquid trichlorosilane to its gaseous state it may not be heated above a specific temperature because doing so results in the trichlorosilane becoming overly corrosive and/or reactive.

Various types of boilers or vaporizers have been used to convert liquid trichlorosilane to its gaseous state. For example, open boilers typically heat a large pool of liquid trichlorosilane and collect the gas that evaporates from the pool. Such open boilers however have yielded unsatisfactory results, as the boilers require a comparatively large surface area in order to vaporize the trichlorosilane without exceeding the specified temperature at which the trichlorosilane becomes overly corrosive and/or reactive. Other types of boilers have been used where liquid trichlorosilane is passed through a long, heated tube. However, these boilers have also yielded unsatisfactory results because of their inability to completely vaporize trichlorosilane without exceeding the temperature at which the trichlorosilane becomes overly corrosive and/or reactive.

### BRIEF SUMMARY

A first aspect is a heat exchanger for vaporizing a liquid comprising a housing, a tube, a heater, and a plurality of non-reactive members. The housing has an interior and an external surface. The tube is disposed in the interior of the housing and has an interior cavity. The tube also has an inlet and an outlet each spaced outward from the external surface of the housing and the inlet is configured for introducing a flow of the liquid into the tube. The heater is disposed in thermal communication with the tube and the housing and is configured to heat the tube. The plurality of non-reactive members are disposed in the interior cavity of the tube in an arrangement such that a plurality of voids are defined between the plurality of non-reactive members and the tube. The arrangement of the plurality of non-reactive members permits the liquid to pass through the plurality of voids and travel from the inlet of the tube to the outlet of the tube. The plurality of non-reactive members and the hollow tube transfer heat to the liquid as the liquid passes through the plurality of voids in order to at least partially vaporize the liquid.

Another aspect is a heat exchanger for vaporizing a liquid comprising a housing, a tube, and a plurality of spherical members. The housing has an interior and an external surface. The tube is disposed in the housing and has an inlet configured for introducing a flow of liquid into the tube. The tube has an interior cavity. The plurality of spherical members are disposed in the interior cavity of the tube in an arrangement such that a plurality of voids are disposed between the plurality of spherical members and the tube. The arrangement of the plurality of spherical members permits the liquid to pass through the plurality of voids and travel from the inlet of the tube to the outlet of the tube. The plurality of spherical members and the tube are configured to transfer heat to the liquid as the liquid passes through the plurality of voids to at least partially vaporize the liquid.

Still another aspect is a method of vaporizing a liquid. The method comprises initiating a flow of the liquid into an inlet of a tube in a heat exchanger, the tube including spherical members. The tube in the heat exchanger is then heated. The liquid is then vaporized into a gas by passing the liquid through the tube. The spherical members are heated by a heat source to transfer heat to the liquid as the liquid passes through a plurality of voids defined between the spherical members and the tube. The gas is then removed from the heat exchanger.

Still another aspect is a method of vaporizing liquid trichlorosilane. The method comprises initiating a flow of liquid trichlorosilane into an inlet of a first heat exchanger. The liquid trichlorosilane is then partially vaporized into a gas state by passing the trichlorosilane through a first tube having a plurality of non-reactive members in the first heat exchanger. The non-reactive members are heated by a first heat source and wherein the non-reactive members transfer heat to the trichlorosilane as the trichlorosilane passes through the non-reactive members. The partially vaporized trichlorosilane is then removed from the first heat exchanger. The partially vaporized trichlorosilane is then mixed with a first gas resulting in a mixture of partially vaporized trichlorosilane and the first gas. A flow of the mixture of partially vaporized trichlorosilane and the first gas is then initiated into a second tube in a second heat exchanger, the second tube including non-reactive members. The mixture of partially vaporized trichlorosilane and the first gas is then vaporized by passing the mixture through the second tube. The non-reactive members are heated by a second heat source and transfer heat to the mixture as the mixture passes through the non-reactive members. The mixture of vaporized trichlorosilane and first gas are then removed from the second heat exchanger.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a cross-section of a heat exchanger of an embodiment;

FIG. 2 is an enlarged view of a portion of the heat exchanger of FIG. 1;

FIG. 3 is a cross-section of a portion of a tube in the heat exchanger of FIG. 2 taken along the 3-3 line;

FIG. 4 is a schematic view of a trichlorosilane vaporization system;

FIG. 5 is a block diagram depicting a method of vaporizing a liquid; and

FIG. 6 is a block diagram depicting a method of vaporizing liquid trichlorosilane.

### DETAILED DESCRIPTION

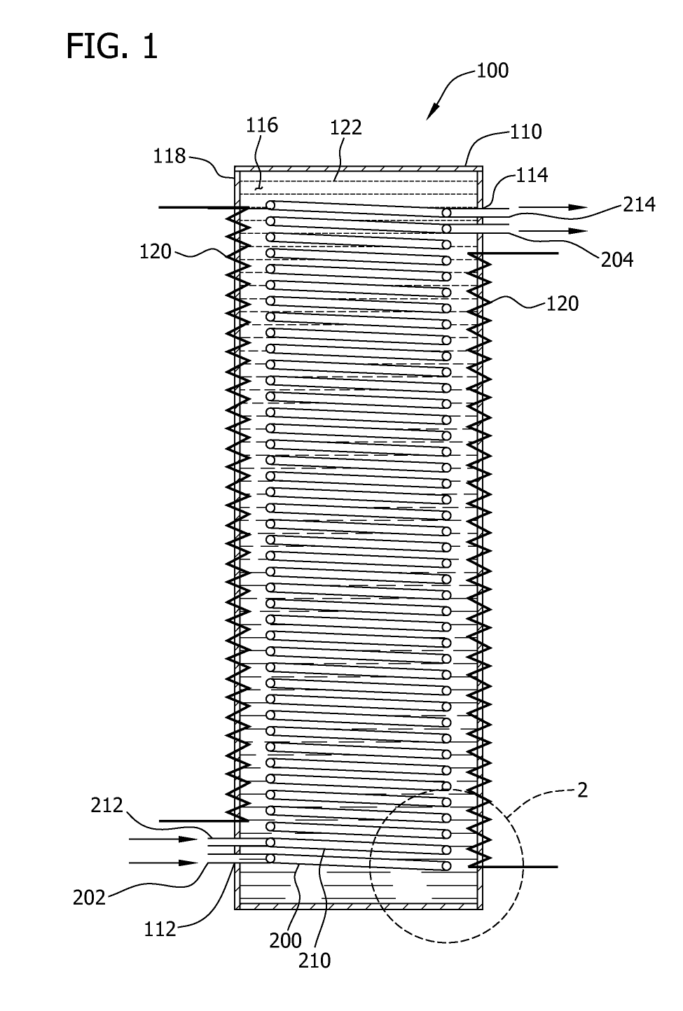

With reference now to the Figures, and in particular to FIG. 1, a heat exchanger is generally indicated at 100. The heat exchanger 100 described herein is used in the vaporization of liquid trichlorosilane (SiCl₃) for subsequent use in the manufacture of silicon-containing devices (e.g., wafers or solar cells). However, the heat exchanger 100 is equally well-suited for use in heating or vaporizing any liquid, and, the heat exchanger may be used for any such purpose without departing from the scope of the disclosure. Reference is also made herein to “vaporizing” trichlorosilane and such reference should be understood to mean converting liquid trichlorosilane to its gaseous state. Partially vaporized trichlorosilane refers to trichlorosilane that has been partially converted to a gas (i.e., some quantity of the trichlorosilane remains in a liquid state).

As shown in FIG. 1, the heat exchanger 100 includes a housing 110 forming an enclosure and an inlet opening 112 and an outlet opening 114. The housing 110 has an interior 116 and an exterior surface 118. The housing 110 is formed from any suitable material, such as steel or alloys thereof. The housing 110 is generally cylindrical in overall shape, although the housing may be differently shaped (e.g., rectangular, square, circular, etc.) without departing from the scope of the disclosure. The housing 110 is also sufficiently sealed (other than the inlet and outlet openings) such that the housing is able to contain a heat transfer liquid 122 (broadly, a heat transfer media) therein (discussed in greater detail below). The housing 110 may also contain a stirrer (not shown) or other device to circulate the heat transfer fluid 122 within the housing

A heater 120 is disposed around at least a portion of the housing 110. The heater 120 is any device suitable for heating the housing 110 and the other components of the heat exchanger 100 disposed within the housing (i.e., tubes, spherical members, heat transfer fluid, and trichlorosilane). The heater 120 is disposed adjacent the housing, and in FIG. 1, is disposed on the exterior surface 118 of the housing 110 while in other embodiments the heater may be disposed in the interior 116 of the housing or instead may be integrally formed with the housing. In FIG. 1, the heater 120 is an electric resistive heater, while in other embodiments the heater may be a radiant or combustion heater. The heater 120 is connected to a suitable control system (not shown) that controls its operation.

A first tube 200 and a second tube 210 are disposed in the interior 116 of the housing 110 in a helical arrangement. In other embodiments, a single tube may be used while in still others more than two tubes may be used. Moreover, the tubes 200, 210 may not be in a helical arrangement and instead may be arranged in any suitable position within the interior 116 of the housing 110. For example, the tubes 200, 210 may be disposed in a looped arrangement within the housing 110.

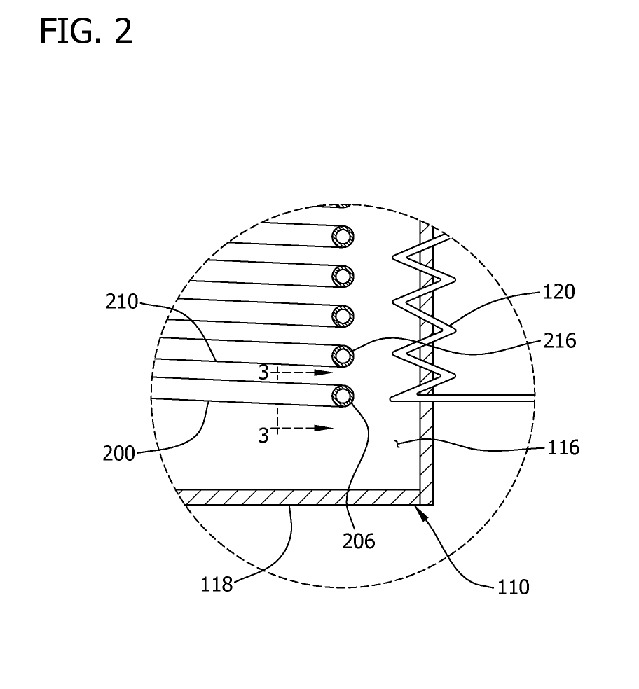

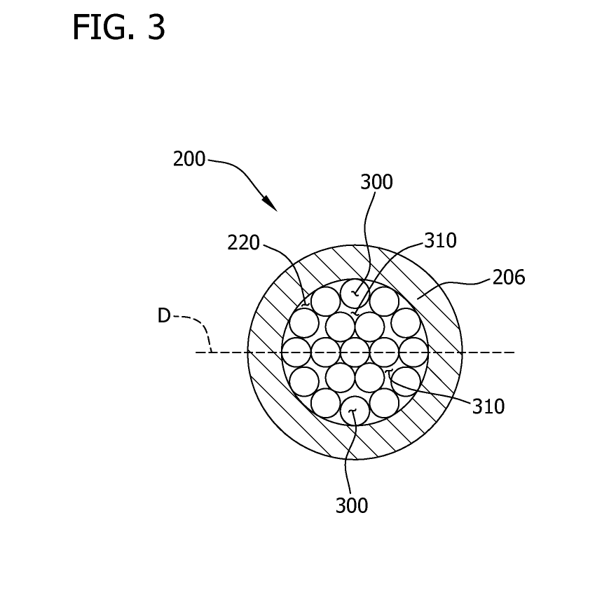

As shown in FIG. 2, the tubes 200, 210 are disposed in the helical arrangement and are each separated from each other by a distance such that the heat transfer fluid 122 can circulate around each of the tubes. The tubes 200, 210 may be separated by a distance equal to about the diameter of the tubes according to one embodiment. Sidewalls 206, 216 of the tubes 200, 210 are impervious to liquids and gases and permit the flow of a liquid (e.g., trichlorosilane) therethrough without the liquid leaking from the tubes. The sidewalls 206, 216 of the tubes 200, 210 are also sufficiently non-reactive in the presence of trichlorosilane at elevated temperatures (e.g., stainless steel or titanium). Each of the tubes 200, 210 has respective inlets 202, 212 and outlets 204, 214. Moreover, each of the tubes 200, 210 has an interior cavity and an interior cavity 220 of the first tube is shown in FIG. 3.

As shown in FIG. 3, spherical members 300 (broadly, “non-reactive members”) are disposed in each of the tubes 200, 210 in a closely packed arrangement such that the spherical members are restricted from movement within the tubes. Retaining members (not shown) may be used at the inlets 202, 212 and outlets 204, 214 of each of the tubes 200, 210 to retain the spherical members 300 within the tubes. The retaining members may have openings formed therein that have a diameter smaller than that of the spherical members 300 in order to allow liquid and/or gas to flow therethrough while preventing the spherical members from doing so. The spherical members 300 are positioned such that heating the housing 110 and tubes 200, 210 by the heater 120 results in the heating of the spherical members.

Voids 310 are defined by empty spaces between the spherical members 300 and the sidewalls 206, 216 of the tubes 200, 210. The voids 310 permit gas to flow through the tubes 200, 210 and the spherical members 300 are sized such that a sufficient amount of liquid and/or gas is able to flow through the voids. For example, each of the spherical members 300 may have a diameter that is less than half of the diameter of the tubes 200, 210. In FIG. 3, the diameter of the spherical members 30 is about 20% of the diameter of the tube 200 and thus five spherical members are intersected by a line D drawn along a diameter of the tube. In one embodiment, the tubes 200, 210 are about 0.75 inches in diameter, the thicknesses of the sidewalls 206, 216 are about 0.065 inches, and the spherical members 300 have a diameter of about 0.125 inches.

Differently sized spherical members 300 may be used in the tubes 200, 210 in order to vary the volume of the voids 310. For example, larger diameter (in relation to the diameter of the tubes) spherical members 300 may be used to increase the volume of the voids 310 since the comparatively larger diameter of the spherical members results in voids having a correspondingly larger volume. Furthermore, smaller diameter spherical members 300 may be used to decrease the volume of the voids 310 and correspondingly increase the total surface area of the spherical members with which the liquid and/or gas comes into contact with as it flows through the voids in the tubes 200, 210. Increasing the surface area of the spherical members 300 contained in the tubes 200, 210 results in both an increased amount and rate of heat transfer to the trichlorosilane flowing through the voids 310 and contacting the spherical members.

The spherical members 300 are formed from a non-reactive material that does not react with or degrade in the presence of trichlorosilane at an elevated temperature. Examples of such materials include various types of stainless steel, titanium, and super alloys. Moreover, while spherical members 300 are shown in FIG. 3, the members may instead be differently shaped. The members 300 may have any geometric shape that allows the members to be disposed in the tubes 200, 210 in a closely packed arrangement that results in the creation of the voids 310 that permit liquid and/or gas to flow therethrough. For example, the members 300 may each have a different shape (e.g., some members may be spherical while others are cubes or different types of polygons) or the members may each be similarly shaped. Moreover, the members 300 may each have different irregular shapes.

The heat transfer fluid 122 is disposed in the interior 116 of the housing 110 and surrounds the tubes 200, 210. The heat transfer fluid 122 is used to transfer heat from the housing 110 and the heater 120 to the tubes 200, 210. Any suitable fluid may be used that has a suitably high thermal conductivity. Examples of suitable heat transfer fluids include liquid metals (e.g., sodium or mercury), water, brine, oils, or combinations thereof. In these embodiments, the tubes 200, 210 may be removed from the housing 110 for servicing (e.g., cleaning) or replacement.

In another embodiment, no heat transfer fluid is used, and instead the tubes 200, 210 are encased in aluminum (i.e., heat transfer media) that surrounds the tubes within the housing 110. The aluminum is first melted to a liquid state and then poured into the housing 110 such that the molten aluminum surrounds the tubes 200, 210 and then solidifies. In this embodiment, aluminum is used to encase the tubes 200, 210 because of its thermal conductivity. In other embodiments, the tubes 200, 210 may be surrounded by a different type of metal.

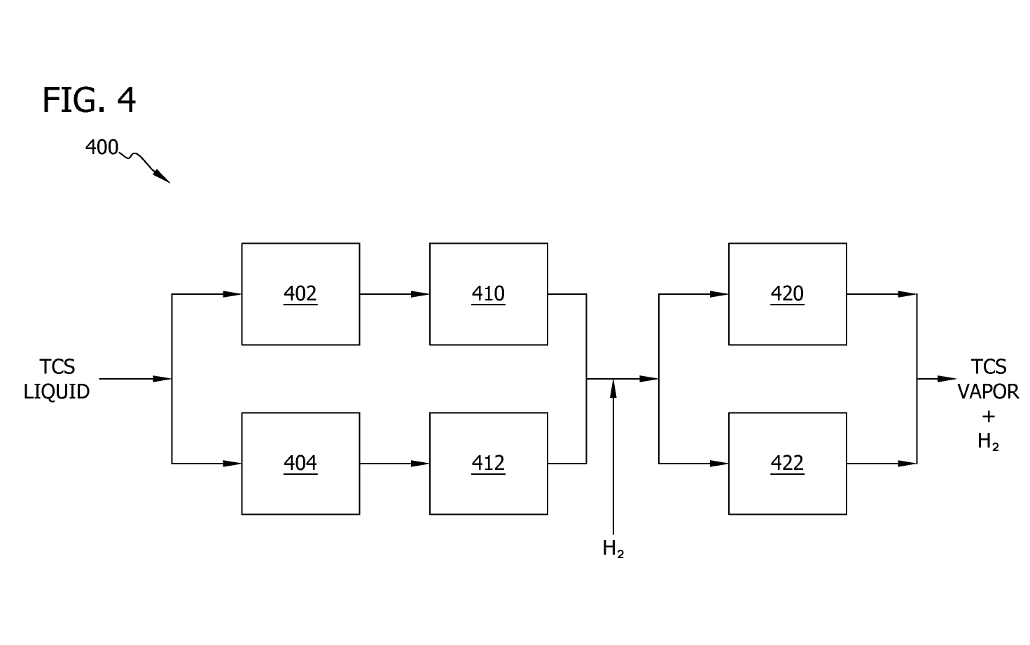

FIG. 4 shows a system 400 for vaporizing liquid trichlorosilane. The system uses multiple heat exchangers similar to or the same as those shown in FIGS. 1-3. The number and configuration of the heat exchangers shown in FIG. 4 is exemplary in nature and may be modified without departing from the scope of the disclosure. For example, the number and configuration of the heaters used in the system 400 can be affected by the flow rate of the liquid being vaporized, boiling point of the liquid, thermal properties of the liquid (e.g., thermal conductivity), and the maximum temperature to which the liquid may be heated.

A flow of liquid trichlorosilane is first split into two parallel flows that are each then fed into a first heat exchanger 402 and a second heat exchanger 404, respectively. The liquid trichlorosilane is then partially vaporized in each of the first and second heat exchangers 402, 404 before being removed (i.e., flowing from the outlet thereof) of each of the respective heat exchangers. The partially vaporized trichlorosilane (i.e., a portion of the trichlorosilane remains in liquid form while another portion is in a gaseous state) is then directed into a third heat exchanger 410 and a fourth heat exchanger 412, respectively. The partially vaporized trichlorosilane is then further vaporized (i.e., the percentage of gaseous trichlorosilane to liquid trichlorosilane is increased) in the third and fourth heat exchangers 410, 412 before being removed from the respective heat exchangers.

The parallel flows of partially vaporized trichlorosilane are then mixed back together and hydrogen gas is mixed with the partially vaporized trichlorosilane. The flow is then split back into two parallel flows that are each then fed into a fifth heat exchanger 420 and a sixth heat exchanger 422, respectively. The partially vaporized trichlorosilane is then further vaporized in the fifth and sixth heat exchangers 420, 422 to a point where substantially all of the trichlorosilane is in a gaseous state. However, a relatively small amount of the trichlorosilane (i.e., less than 1% by weight) may remain in liquid form upon exiting the fifth and sixth heat exchangers 420, 422. The parallel flows of vaporized trichlorosilane are then brought back together into a single tank and stored for later use or directed to a subsequent processing operation.

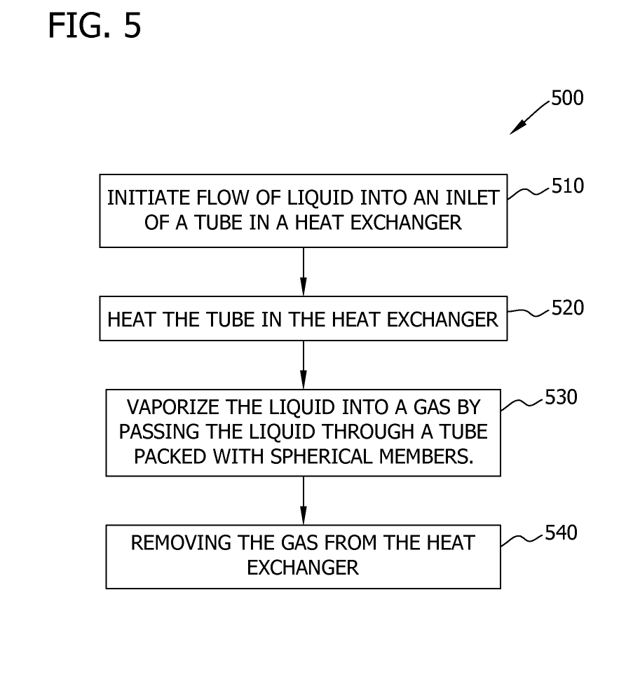

FIG. 5 depicts a method 500 of vaporizing a liquid in a heat exchanger described above in relation to FIGS. 1-3. The method begins in block 510 with the initiation of a flow of a liquid (e.g., a temperature-sensitive liquid such as trichlorosilane) into an inlet of a tube in a heat exchanger. In block 520 the tube in the heat exchanger is heated by a heater or other heat source. The liquid is then vaporized into a gas in block 530 by passing the liquid through the tube in the heat exchanger packed with spherical members. The liquid is vaporized by heat transferred to the liquid from the spherical members within the tube. The gas is then removed from the tube in the heat exchanger in block 540 and either stored or used in a subsequent processing operation.

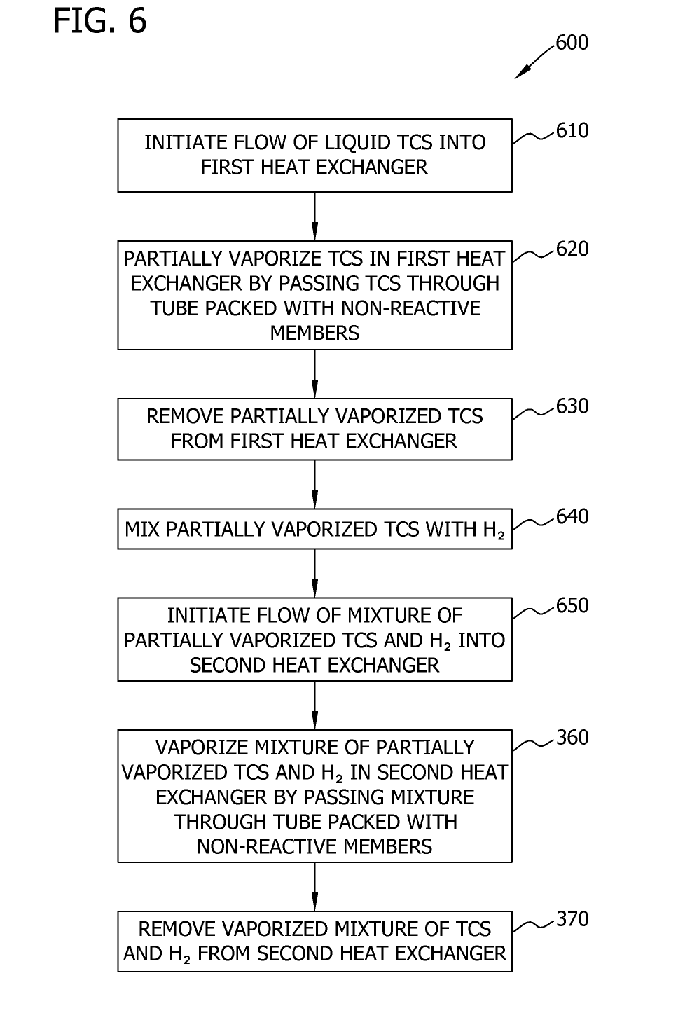

FIG. 6 depicts a method 600 of vaporizing liquid trichlorosilane in a trichlorosilane vaporization similar to or the same as that shown above in FIG. 4. The method begins in block 610 with the initiation of a flow of liquid trichlorosilane in the first heat exchanger. The liquid trichlorosilane is then partially vaporized in block 620 in the first heat exchanger by passing the trichlorosilane through a tube packed with non-reactive member (e.g., the spherical members described above in FIGS. 1-3).

In block 630, the partially vaporized trichlorosilane is removed from the first heat exchanger. The partially vaporized trichlorosilane is then mixed with hydrogen gas in block 640. The mixture of partially vaporized trichlorosilane and hydrogen gas is then directed into a second heat exchanger. Once in the second heat exchanger, the mixture is then vaporized in block 650 by passing the mixture through a tube in the second heat exchanger that is packed with non-reactive members. In block 670, the vaporized mixture of trichlorosilane and hydrogen gas is then removed from the second heat exchanger.

Without being bound to any particular theory, it is believed that the spherical members disposed in the tube increase the rate and amount of heat transferred to the trichlorosilane because the spherical members increase the surface area of the heat exchanger in contact with the trichlorosilane. The increase in surface area of the heat exchanger in contact with the trichlorosilane permits more heat to be transferred to the trichlorosilane at a greater rate than possible in conventional tube-type heat exchangers. In operation, as the liquid trichlorosilane begins to vaporize and the proportion of gaseous to liquid trichlorosilane increases, the heat transfer coefficient increases. This increase in the heat transfer coefficient significantly decreases the rate and amount of heat transferred to the partially vaporized trichlorosilane. In traditional tube-type heat exchangers that do not use the spherical members, it takes longer to convert the remaining amount of liquid trichlorosilane to a gaseous state as compared to embodiments of this disclosure. Accordingly, the tubes must be increasingly longer or the flow rate of trichlorosilane must be reduced in order to ensure that enough heat is transferred to the trichlorosilane in order vaporize the trichlorosilane. As described above, merely increasing the temperature of the heat exchanger is not a viable option to increase the rate of vaporization because at temperatures above a specific temperature (e.g., 450° F.) trichlorosilane becomes overly corrosive and reactive. Thus, in traditional tube-type heat exchangers it becomes increasingly difficult, if not impossible, to completely vaporize the trichlorosilane.

The heat exchangers and spherical members described above greatly increase the surface area of the heat exchanger (i.e., the surface area of the tubes and the spherical members) in contact with the trichlorosilane passing through the heat exchanger. This increase in surface area results in a corresponding increase in the ability of the heat exchanger to transfer heat to the trichlorosilane even when a substantial portion of the trichlorosilane has been vaporized. Accordingly, the increase in the rate and amount of heat transferred to the trichlorosilane results in substantially all of the liquid trichlorosilane being converted to its gaseous state. The efficiency of the heat exchanger described above is also increased because a greater amount of heat is transferred to the trichlorosilane and the liquid trichlorosilane is more quickly converted to its gaseous state when compared to traditional tube-type heat exchangers. Due to its increased efficiency, the comparative size, length of tubes, and amount of heat required to vaporize the trichlorosilane are reduced when compared to traditional tube-type heat exchangers. This reduction in the comparative size, length of the tubes, and amount of heat required to vaporize the trichlorosilane also significantly reduces both the capital costs (i.e., the actual cost of the components of the system) associated with vaporizing trichlorosilane and the operational costs of the system.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of the present invention or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

What is claimed is:

1. A heat exchanger for vaporizing a liquid comprising:
a housing having an interior and an external surface;
a tube disposed in the interior of the housing, the tube having an interior cavity, the tube having an inlet and an outlet each spaced outward from the external surface of the housing, the inlet configured for introducing a flow of the liquid into the tube;
a heater disposed in thermal communication with the tube and the housing and configured to heat the tube;
a plurality of non-reactive members disposed in the interior cavity of the tube in an arrangement such that a plurality of voids are defined between the plurality of non-reactive members and the tube, wherein the arrangement of the plurality of non-reactive members permits the liquid to pass through the plurality of voids and travel from the inlet of the tube to the outlet of the tube; and
wherein the plurality of non-reactive members and the hollow tube transfer heat to the liquid as the liquid passes through the plurality of voids in order to at least partially vaporize the liquid.

2. The heat exchanger of claim 1 wherein the tube is disposed in the interior of the housing in a helical arrangement.

3. The heat exchanger of claim 1 wherein the plurality of non-reactive members are spherically shaped.

4. The heat exchanger of claim 3 wherein the plurality of non-reactive members include metal.

5. The heat exchanger of claim 1 wherein each of the plurality of non-reactive members have a diameter that is less than half a diameter of the tube.

6. The heat exchanger of claim 1 further comprising a heat transfer media disposed in the interior of the housing and at least partially surrounding the tube.

7. A heat exchanger for vaporizing a liquid comprising:
a housing having an interior and an external surface;
a tube disposed in the housing, the tube having an inlet configured for introducing a flow of liquid into the tube, the tube having an interior cavity;
a plurality of spherical members disposed in the interior cavity of the tube in an arrangement such that a plurality of voids are disposed between the plurality of spherical members and the tube, wherein the arrangement of the plurality of spherical members permits the liquid to pass through the plurality of voids and travel from the inlet of the tube to the outlet of the tube, and wherein the plurality of spherical members and the tube are configured to transfer heat to the liquid as the liquid passes through the plurality of voids to at least partially vaporize the liquid.

8. The heat exchanger of claim 7 wherein the plurality of spherical members together have a volume of at least about 30 percent of a volume of the tube.

9. The heat exchanger of claim 7 wherein a heater is configured to heat the tube, the heater disposed adjacent the housing.

10. The heat exchanger of claim 7 wherein a heater is positioned adjacent one of the exterior surface of the housing and the interior of the housing.

11. The heat exchanger of claim 7 wherein the spherical members include at least one of stainless steel and titanium.

12. The heat exchanger of claim 7 wherein each of the plurality of spherical members has a diameter that is less than about 25% of a diameter of the tube.

13. The heat exchanger of claim 7 further comprising:
a second tube disposed in the interior of the housing and having an inlet configured for introducing a flow of liquid into the second tube and an outlet, the second tube having an interior cavity; and
a second plurality of spherical members disposed in the interior cavity of the tube in an arrangement such that a second plurality of voids are disposed between the second plurality of spherical members and the second tube, wherein the arrangement of the second plurality of spherical members permits the liquid to pass through the second plurality of voids and travel from the inlet to the outlet of the second tube, and wherein the plurality of spherical members and the tube are configured to transfer heat from a heat to the liquid as the liquid passes through the second plurality of voids to at least partially vaporize the liquid.

14. A method of vaporizing a liquid, the method comprising:
initiating a flow of the liquid into an inlet of a tube in a heat exchanger, the tube including spherical members;
heating the tube in the heat exchanger;
vaporizing the liquid into a gas by passing the liquid through the tube, wherein the spherical members are heated by a heat source and wherein the spherical members transfer heat to the liquid as the liquid passes through a plurality of voids defined between the spherical members and the tube; and
removing the gas from the heat exchanger.

15. The method of vaporizing a liquid of claim 14 wherein the tube in the heat exchanger is heated by a resistive heater.

16. The method of vaporizing a liquid of claim 14 wherein the spherical members are disposed in an interior cavity of the tube such that the liquid is able to flow through a plurality of voids disposed between the plurality of spherical members.

17. The method of vaporizing a liquid of claim 14 further comprising mixing the gas removed from the heat exchanger with a first gas.

18. A method of vaporizing liquid trichlorosilane, the method comprising:
initiating a flow of liquid trichlorosilane into an inlet of a first heat exchanger;
partially vaporizing the liquid trichlorosilane into a gas state by passing the trichlorosilane through a first tube having a plurality of non-reactive members in the first heat exchanger, wherein the non-reactive members are heated by a first heat source and wherein the non-reactive members transfer heat to the trichlorosilane as the trichlorosilane passes through the non-reactive members;
removing the partially vaporized trichlorosilane from the first heat exchanger;
mixing the partially vaporized trichlorosilane with a first gas, resulting in a mixture of partially vaporized trichlorosilane and the first gas;
initiating a flow of the mixture of partially vaporized trichlorosilane and the first gas into a second tube in a second heat exchanger, the second tube including non-reactive members;
vaporizing the mixture of partially vaporized trichlorosilane and the first gas by passing the mixture through the second tube, wherein the non-reactive members are heated by a second heat source and wherein the non-reactive members transfers heat to mixture as the mixture passes through the non-reactive members; and
removing the mixture of vaporized trichlorosilane and first gas from the second heat exchanger.

19. The method of claim 18 wherein the non-reactive members in the first tube and the second tube are a plurality of spherical members formed from one of stainless steel and titanium.

20. The method of claim 19 wherein each of the plurality of spherical members in the first tube have a diameter less than half of a diameter of the first tube and wherein each of the plurality of spherical members in the second tube have a diameter less than half of a diameter of the second tube.
